(19) United States
(12) Patent Application Publication
(10) Pub. No.: US 2013/0166752 A1
(43) Pub. Date: Jun. 27, 2013

(54) METHOD FOR DISTRIBUTING AND MANAGING INTERDEPENDENT COMPONENTS

(71) Applicants: Kilhwan KIM, Daejeon (KR); Hyun Joo BAE, Daejeon (KR)

(72) Inventors: Kilhwan KIM, Daejeon (KR); Hyun Joo BAE, Daejeon (KR)

(73) Assignee: Electronics and Telecommunications Research Institute, Daejeon (KR)

(21) Appl. No.: 13/619,654

(22) Filed: Sep. 14, 2012

(30) Foreign Application Priority Data
Dec. 23, 2011 (KR) 10-2011-0141294

(51) Int. Cl. G06F 15/173

(52) U.S. Cl. 709/226

(57) ABSTRACT

A method for distributing components of a distributed computing system, according to an embodiment of the present invention, includes determining an appropriate number of available server instances, classifying a plurality of components loaded on the distributed computing system into clusters of which the number is equal to the number of the available server instances with reference to interdependent relations among the components, calculating an amount of computing resources required for each of the component clusters classified, rearranging the component clusters to adjust each of the amount of computing resources required for the component clusters to a value within an appropriate range, and deploying the component clusters, of which the computing resource request amounts are adjusted, to the available server instances.

### CROSS-REFERENCE TO RELATED APPLICATIONS

This U.S. non-provisional patent application claims priority under 35 U.S.C. §119 of Korean Patent Application No. 10-2011-0141294, filed on Dec. 23, 2011, the entire contents of which are hereby incorporated by reference.

### BACKGROUND OF THE INVENTION

The present invention disclosed herein relates to distributed computing, and more particularly, to a method for dynamically distributing and managing interdependent components in a distributed computing environment for cloud computing or a data center.

Cloud computing is widely used in order to construct a rapid and convenient distributed computing environment. Also the module- or component-based development technology for rapidly implementing an application by using reusable modules or components has gained great attention. As examples of this technology, there are CORBA, service oriented computing (SOA), service component architecture (SCA), open service gateway initiative (OSGi), etc.

One of the best advantages of a cloud computing service is that computing capacity may be rapidly adjusted via a “cloud” without additional investment in computing resources. Particularly, in the case of providing an application such as a web service used by external users, an amount of computing resources required may frequently fluctuate according to an increase/decrease in application usage. Therefore, the cloud computing service would be a more efficient method for using computing resources.

In the cloud computing service, e.g., Amazon EC2, processing capacity for an application is elastically adjusted according to the increase/decrease in application usage. For example, the number of virtual servers on which an instance of the application is deployed is dynamically adjusted. To perform such adjusting automatically, an elastic load balancer appropriately distributes user requests among the virtual servers, and monitors the utilization of the virtual servers. Also the cloud computing service has the preconfigured image of a virtual server on which an instance of the application is deployed so as to automatically generate or remove new virtual server instances when a suitable condition of the utilization of the virtual servers is satisfied.

However, when applications depend on reusable components, this technique of adjusting the processing capacity for an application by adjusting the number of virtual server instances with a preconfigured server image is effective only when an application configuration is stably maintained. When multiple applications composed of reusable components are provided and their component dependencies are constantly changed, it is very difficult to appropriately distribute components used by the applications to several server images and to determine appropriate numbers of the different server image instances according to the application usages.

An application platform as a service (APaaS) provider may be a representative example. The APaaS provider provides an application development and execution environment with a wide range of reusable components so as to allow a plurality of users to rapidly construct their own applications. In this case, the APaaS provider needs to dynamically determine which components are more used by the applications and to appropriately distribute the components on clusters of servers. Also, when an online service provider shortens a new service introduction period by using the reusable modules and components, the component configurations on the servers need to be rapidly changed. Moreover, when the above-mentioned providers globally provide services, it may be needed to differently configure server images and their instances according to regionally different demands of applications and components.

Further, when introduction, change, and removal of the reusable modules and components rapidly occur with the rapid changes of applications, the technique of dynamically adjusting the number of server instances after preconfiguring server images may increase management cost. In this case, as types of applications, modules, and components increase, the management cost increases. Therefore, it is needed to develop a method for automatically provisioning corresponding interdependent applications and components to a plurality of servers according to an increase/decrease in usage of a plurality of applications and components and for distributing related loads.

### SUMMARY OF THE INVENTION

The present invention provides a method for dynamically provisioning interdependent applications and components to a plurality of server instances according to an increase/decrease in usage.

Embodiments of the present invention provide methods for distributing components of a distributed computing system, including determining an appropriate number of available server instances, classifying a plurality of components loaded on the distributed computing system into clusters of which the number is equal to the number of the available server instances with reference to interdependent relations among the components, calculating an amount of computing resources required for each of the component clusters classified, rearranging the component clusters to adjust the amount of computing resources required for each component cluster to a value within an appropriate range, and deploying the components clusters, of which the computing resource request amounts are adjusted, to the available server instances.

In other embodiments of the present invention, methods for managing components of a distributed computing system include determining whether it is needed to redistribute components, allocating one component to a server instance which loads the more components having interdependent relations with the one component when component redistribution is needed, and adjusting components allocation for the server instance with reference to a computing resource request amount or usage amount.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a diagram illustrating interdependency between applications and components;

FIG. 2 is a schematic block diagram illustrating a distributed computing system to which a provisioning method according to an embodiment of the present invention is applied;

FIG. 3 is a flowchart illustrating a component redistribution method according to an embodiment of the present invention;

FIG. 4 is a schematic flow chart illustrating a method for redistributing components when a new component is installed;

FIG. 5 is a flow chart illustrating a method for redistributing components when a particular component loaded on a server instance is removed;

FIG. 6 is a flow chart illustrating a method for redistributing components when an amount of required resources for a particular component is increased or decreased; and

FIG. 7 is a flow chart illustrating a method for redistributing components when an amount of resources used by all components is increased.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

In the description, when it is described that a certain part includes certain elements, the part may further include other elements. Further, the embodiments exemplified and described herein include complementary embodiments thereof. Hereinafter, an embodiment of the present invention will be described in detail with reference to the accompanying drawings.

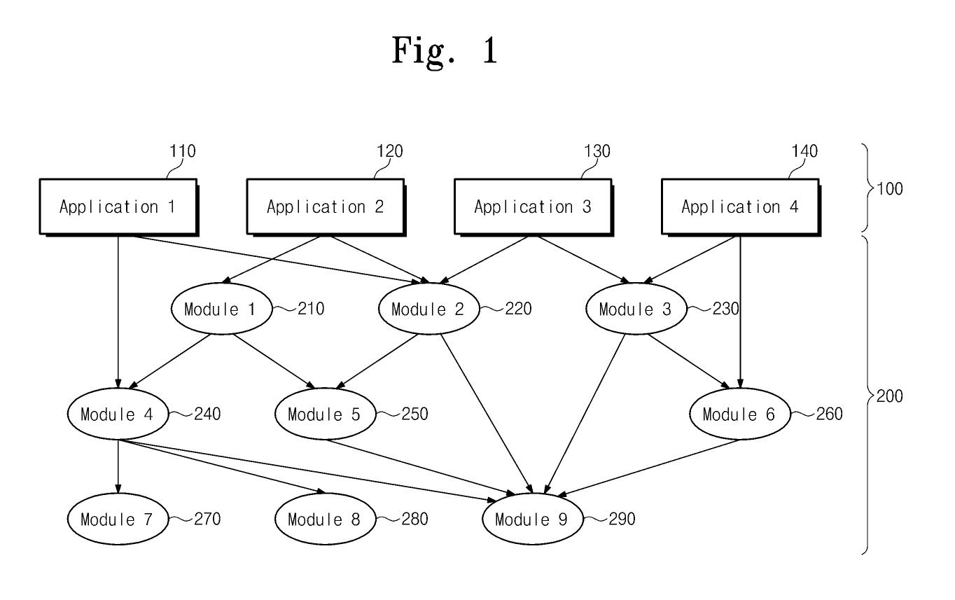

FIG. 1 is a diagram illustrating interdependency between applications and modules or components. Referring to FIG. 1, interdependency among a plurality of applications 100 and a plurality of modules 200 is indicated by arrows. Four applications 110 to 140 are exemplarily illustrated for the plurality of applications 100. Nine modules 210 to 290 are exemplarily illustrated for the plurality of modules 200.

It is assumed that modules having interdependent relations with the second application 120 are loaded on a first server instance (not illustrated). Further, it is assumed that modules having interdependent relations with the fourth application 140 are loaded on a second server instance (not illustrated). Herein, if the first application 110 should be newly loaded, it is preferable to load the first application 110 on the first server instance. This is because an amount of time for loading a module needed during provisioning of the first application 110 may be reduced. Moreover, when the first application 110 is executed, the execution time may be reduced since related modules are in the same server instance. This is because that the second and fourth modules 220 and 240 having interdependent relations with the second application 120 are previously stored in the first server instance.

If the first application 110 is loaded on the first server instance, it is not needed to load additional modules. However, in order to load the fourth application 140 on the first server instance, it is needed to load the fourth application 140 and module having interdependent relations therewith (i.e., third, sixth, and ninth modules). This is because that the fourth application 140 does not use the second and fourth modules 220 and 240 previously loaded on the first server instance.

Therefore, it is needed to efficiently provision applications and modules and to efficiently distribute loads considering interdependent relations there among. In addition, the development of a module- or component-based technology increases interdependency among the applications and modules. This interdependent relation may be a very important factor for efficient provisioning and executing of the applications.

An application and a module have been distinguished from each other until now. However, a single application may consist of at least one module which is a minimum execution unit of a particular function. Therefore, hereinafter, a module or application will be referred to as a component which is a unit of a program corresponding to a particular function.

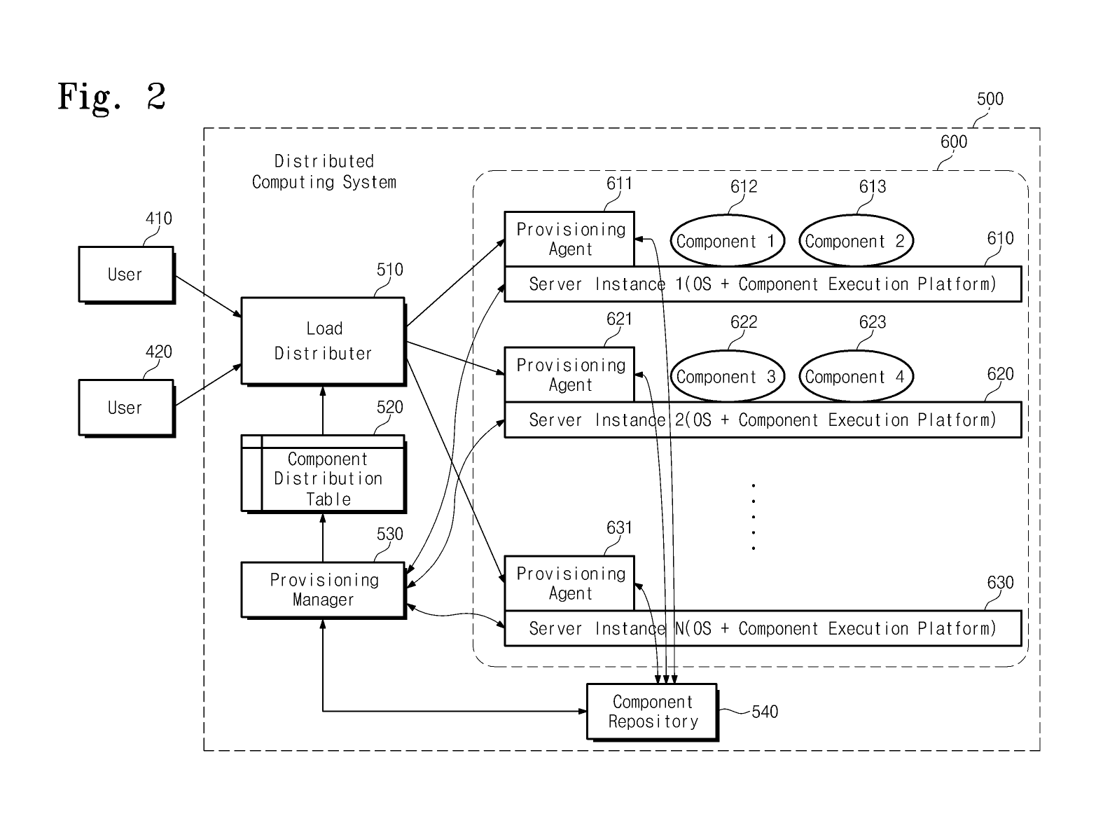

FIG. 2 is a schematic block diagram illustrating a distributed computing system to which a provisioning method according to an embodiment of the present invention is applied. Referring to FIG. 2, a distributed computing system 500, to which the provisioning method according to the present invention is applied, includes a load distributer 510, a component distribution table 520, a provisioning manager 530, a component repository 540, and a server virtual cluster 600.

The load distributer 510 performs routing to an optimal server instance of an application or component in response to requests of users 410 and 420. The load distributer 510, in order to perform operations requested from the users 410 and 420, selects the optimal server instance from the server virtual cluster 600 with reference to the component distribution table 520.

The component distribution table 520 stores a distribution state of an application or component. The component distribution table 520 may be updated by the provisioning manager 530. When the distribution state of components is changed by the provisioning manager 530, the distribution state is finally written in the component distribution table 520. Then, the load distributer 510 controls provisioning agents 611, 621, and 631 with reference to the component distribution table 520 updated.

The provisioning manager 530 determines the number of server instances considering interdependent relations among components (applications or modules) and their usages. Further, the provisioning manager 530 determines how to allocate components to the determined server instances 610, 620, and 630. The provisioning manager 530 inputs, into the component distribution table 520, allocation information on components respectively allocated to the server instances 610, 620, and 630.

The component repository 540 stores an image of all components (applications or modules) according to control by the provisioning manager 530. Newly added components are firstly stored in the component repository 540. When new components are added or firstly executed, the new components may be loaded on a server instance to which the new components are allocated. The component repository 540 may delete a component according to control by the provisioning manager 530.

The server virtual cluster 600 includes the plurality of server instances 610, 620, and 630 and the provisioning agents 611, 621, and 631 respectively corresponding thereto. Further, the server virtual cluster 600 includes components 612, 613, 622, and 623 respectively loaded on the server instances 610, 620, and 630. Herein, the provisioning agents 611, 621, and 631 respectively corresponding to the server instances may install or delete components on or from the server instances according to control by the provisioning manager 530. When components requested to be executed do not exist in corresponding server instances, the provisioning agents 611, 621, and 631 may download the components from the component repository 540 to install and execute the components. Further, the provisioning agents 611, 621, and 631 may set an idle state for components not used for a long time, or may delete the components from corresponding server instances. In each of instances 610, 620, and 630, a platform and an operating system (OS) for executing components (application or modules) are installed.

Herein, the provisioning manager 530 carries out one of the most important roles in the distribution computing system 500. When components are newly introduced or deleted, the provisioning manager 530 appropriately redistributes components to the server instances 610, 620, and 630. Further, the provisioning manager 530 may appropriately redistribute components to the server instances 610, 620, and 630 according to increase/decrease in usage of components. By virtue of this component redistribution, efficiency of the distribution computing system 500 may be improved. A component redistribution method performed by the provisioning manager 530, according to an embodiment of the present invention, needs to satisfy the following conditions described in Table 1.

TABLE 1
\textcircled{1} Components having similar interdependent relations should be deployed in the
same server instance by detecting interdependent relations among the components.
Accordingly, an amount of time for provisioning of a new component may be
reduced in deployment time and an amount of time for invocation among
components may be reduced in runtime.
\textcircled{2} Even though the components having similar interdependent relations are
provisioned to the same server instance, performance may be degraded when usage
thereof is excessive. In this case, the components having similar interdependent
relations should be allowed to be distributed to different server instances.
\textcircled{3} Redistribution of components to new or previous server instances should be
autonomously performed according to a change of component configuration or usage
so that load balancing may be easily performed.
\textcircled{4} When components are redistributed to new or previous server instances,
reallocation of the components should be minimized so as to improve the efficiency
of server maintenance.

The provisioning manager 530 according to an embodiment of the present invention uses the component redistribution method capable of satisfying all the above-mentioned conditions. Therefore, performance of a distributed computing system may be efficiently managed.

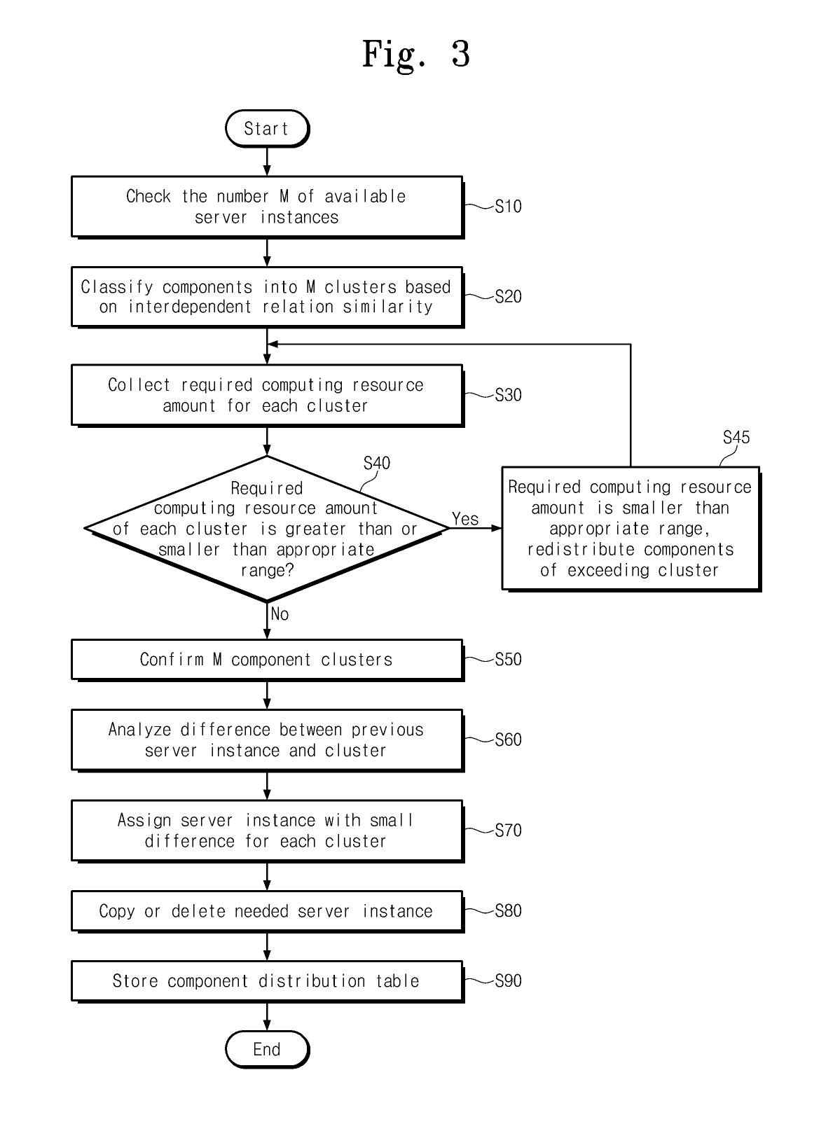

FIG. 3 is a flowchart illustrating the component redistribution method according to an embodiment of the present invention. The component redistribution method according to an embodiment of the present invention will be described with reference to FIG. 3.

In operation S10, the number M of available server instances is determined. The provisioning manager 530 (see FIG. 2) adjusts the number M of available server instances according to utilization thereof. The number M of available server instances may be automatically adjusted to according to a predetermined range of average server utilization.

In operation S20, the provisioning manger 530 classifies components into groups as much as the number M of available server instances considering interdependent relations among the total components. That is, the provisioning manager 530 classifies the total components into clusters, the number of which corresponds to the number M of available server instances, according to similarities of interdependent relations.

The similarity of interdependent relations may be exemplarily determined as follows. In the case where the total number of components is w, in order to measure the similarities among components, any component is expressed by ‘1’ and ‘0’ according to dependency on all components so as to be expressed in w-dimensional coordinates. According to distances among coordinates, the similarities may be measured. For the classification into the M clusters by using distances among components, the K-means algorithm for clustering close points may be used.

In operation S30, when the classification into the M clusters is completed, the provisioning manager 530 calculates a total amount of computing resources required for each component cluster. The provisioning manger 530 may calculate the amount of computing resources required for each component cluster by using data on an amount of required computing resources (CPU usage, memory usage, and network bandwidth usage) for each component, which are collected for a certain period of time.

In operation S40, it is determined whether there is a component cluster of which the total amount of required computing resources is relatively too small or too great in comparison with computing capacity of a server instance. If the total amount of computing resources required for each component cluster is an appropriate value, the procedures move on to operation S50 for confirming clusters. However, if there is a component cluster of which the total amount of required computing resources is less than a lower limit of the appropriate value or greater than an upper limit thereof, the procedures move on to operation S45 for redistributing components for the cluster.

In operation S45, the component redistribution operation is performed for the component cluster of which the total amount of required computing resources is out of an appropriate range. In this case, components may be reallocated to another cluster from the corresponding cluster. For this reallocation, a heuristic algorithm described in operations S45-1 to S45-3 may be used.

In operation S45-1, in the case where the total amount of computing resources required for a component cluster is so small as to be less than the lower limit of the appropriate value, components of another cluster that is closest to a center of the corresponding cluster (since a component is expressed in the w-dimensional coordinates, a center of a cluster may be calculated) are sequentially included. Repeat this operation until the total amount of required computing resources is increased to be equal to or higher than the lower limit of the appropriate value.

In operation S45-2, in the case where the total amount of computing resources required for a component cluster is greater than the upper limit of the appropriate value, the farthest component from a center of the corresponding cluster is moved into another cluster which is close to the center of the corresponding cluster. Repeat this operation until the total amount of computing resources required for the corresponding cluster is reduced to be equal to or lower than the upper limit of the appropriate value.

After the total amount of required computing resources is adjusted in operation S45-1 or S45-2, the procedures move on for recalculating a center of each cluster, and then for reclassification into M clusters by reusing the K-means algorithm. Then, the procedures move on to operation S30. In this manner, through a loop of operations S30, S40, and S45, the total amount of computing resources required for each of the M clusters may be adjusted to an appropriate level.

In operation S50, when an amount of computing resources used by all the M component clusters reaches an appropriate value, component clusters to be allocated to respective server instances are confirmed.

In operation S60, a difference between each component cluster and a previous server instance is analyzed. Each component cluster is compared with every previous server instance with respect to the component configuration of the server instance.

In operation S70, when a configuration of components previously loaded on a server instance is least different from that of a corresponding component cluster, the server instance is determined as an initial server instance of the corresponding component cluster. One of the simplest methods for choosing a server instance with a minimum difference from a component cluster is to select a server instance which includes the most components included in a component cluster, and select a server instance which includes the least components that are not included in the cluster in the case of a tie in the score of the number of components included in the cluster.

In operation S80, when there is a sever instance which is not selected by any component cluster, this server instance is removed by the provisioning manager 530. When a plurality of component clusters select a single server instance as an initial server instance, this server instance is copied as much as the number of the component clusters, and each copy of the server instance is allocated to each of the clusters.

In operation S90, all components of a component cluster are distributed to an initial server instance of the component cluster, and then the component distribution table 520 (see FIG. 2) is changed and stored.

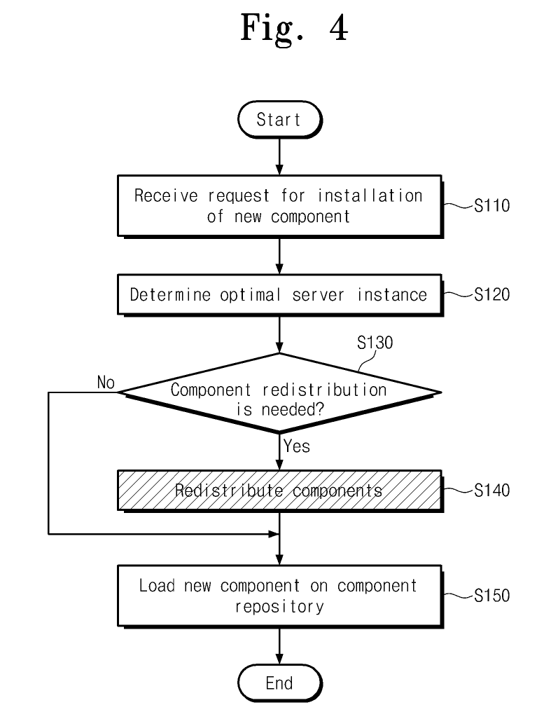

FIGS. 4 to 7 are diagrams illustrating methods for redistributing components according to tinstallation/uninstallation of components or a change of component usage. FIGS. 4 to 7 illustrate methods for redistributing components respectively when a new component is installed, when a component is removed, when an amount of required resources for a particular component is increased or decreased, and when an amount of required resources for total components is increased or decreased.

FIG. 4 is a schematic flow chart illustrating the method for redistributing components when a new component is installed. Referring to FIG. 4, when a new component is requested to be installed, components respectively installed on server instances may be reconfigured.

In operation S110, a new component may be needed to be installed according to a request from the users 410 and 420 or according to a change of a computing environment. Herein, the provisioning manager 530 may receive a request for installing of a new component.

In operation S120, the provisioning manger 530 detects interdependent relations between the new component requested to be installed and components previously loaded on respective server instances. With reference to the interdependent relations, the provisioning manager 530 determines an optimal server instance for installing the new component among the server instances. For example, the provisioning manager 530 may determine a server instance, which has the most components required by the new component, as a server instance for installing the new component. Thereafter, the provisioning manager 530 writes, onto the component distribution table 520, a mapping relation between the selected server instance and the new component.

In operation S130, the provisioning manager 530 determines whether it is needed to redistribute components on the server instances of the distributed computing system according to the installation of the new component. That is, the provisioning manager 530 may determine whether there is a server instance of which the total amount of required computing resources exceeds the upper limit of the appropriate value due to the installation of the new component. When the amount of required computing resources of each of all server instances is within the appropriate range, the procedures move on to operation S150. On the contrary, when there is a server instance of which the total amount of required computing resources exceeds the upper limit of the appropriate value due to the installation of the new component, the procedures move on to operation S140 for redistribution of components.

In operation S140, since there is a server instance of which the total amount of required computing resources exceeds the upper limit of the appropriate value due to the new component, components are redistributed for efficient server utilization. The component redistribution may be performed through the above-described operations (loop of S30, S40, and S45) of FIG. 3. By virtue of the component redistribution, the total amount of required computing resources of each of all clusters including the new component may be adjusted to an appropriate value.

In operation S150, the provisioning manager 530 preferentially loads the new component on the component repository 540. The new component temporarily loaded on the component repository 540 may be loaded on a corresponding server instance when execution of the new component is firstly requested. However, in the case where components having interdependent relations with the new component should also be provisioned during provisioning of the new component, the new component may be pre-provisioned to an appropriate server instance.

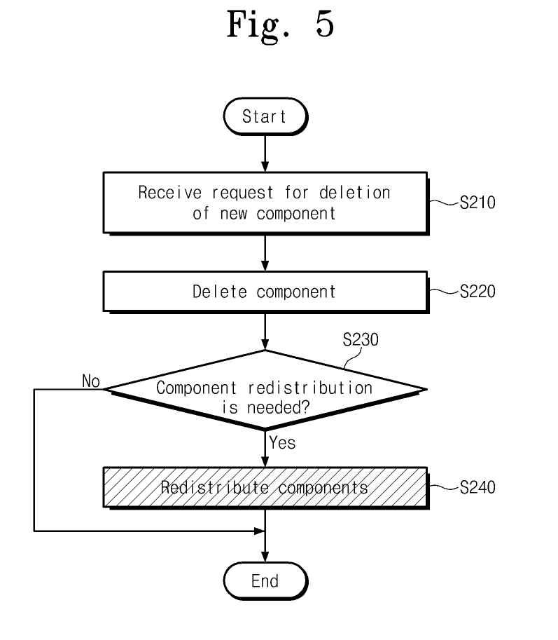

FIG. 5 is a flow chart illustrating the method for redistributing components when a particular component loaded on a server instance is removed. Referring to FIG. 5, when a particular component is requested to be deleted, components respectively installed on server instances may be reconfigured.

In operation S210, a particular component or application may be needed to be uninstalled according to a request from the users 410 and 420 or according to a change of a computing environment. Herein, the provisioning manager 530 may receive a request for uninstallation of the particular component.

In operation S220, the provisioning manager 530 removes the component requested to be uninstalled from the component repository 540. The provisioning manager 530 notifies the component to be uninstalled to a provisioning agent (one of 611, 621, and 631) of a server instance on which the component to be uninstalled is loaded. Then, according to an instruction from the provisioning manager 530, the provisioning agent (one of 611, 621, and 631) removes the component from a corresponding server instance. However, there may be another component which is using the component to be removed. In this case, the provisioning agent (one of 611, 621, and 631) may provide a certain period of time for postponement before removing the component. Then, the provisioning agent may remove the component which has been determined to be removed from the corresponding server instance after stably suspending the component having an interdependent relation with the component to be removed.

In operation S230, the provisioning manager 530 determines whether it is needed to redistribute components on the server instances of the distributed computing system according to the removal of the component. That is, the provisioning manager 530 may detect whether there is a server instance of which the total amount of required computing resources is lower than the lower limit of the appropriate value due to the removal of the component. When the amount of required computing resources of each of all server instances is within the appropriate range, the procedures for the component removal are finished. On the contrary, when there is a server instance of which the total amount of required computing resources is lower than the lower limit of the appropriate value due to the removal of the component, the procedures move on to operation S240 for redistribution of components.

In operation S240, since there is a server instance of which the total amount of required computing resources is lower than the lower limit of the appropriate value due to the component removal, components are redistributed for efficient server utilization. The component redistribution may be performed through the above-described operations (loop of S30, S40, and S45) of FIG. 3. By virtue of the component redistribution, the total amount of required computing resources of each of all clusters may be adjusted to an appropriate value.

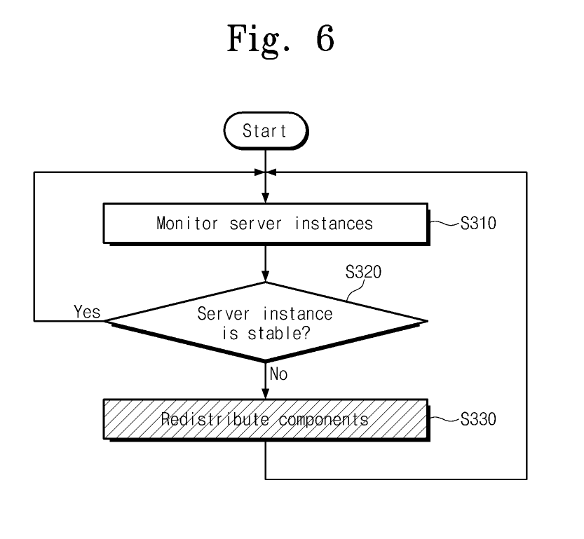

FIG. 6 is a flow chart illustrating the method for redistributing components when an amount of required resources for a particular component is increased or decreased. Referring to FIG. 6, when an amount of computing resources required for a particular component is changed, it is needed to redistribute components.

In operation S310, the provisioning manager 530 monitors the server instances 610, 620, and 630. The provisioning manager 530 may monitor applications or components executed in the server instances 610, 620, and 630 to thereby monitor an amount of computing resources used by each customer cluster.

In operation S320, the provisioning manager 530 determines whether an amount of computing resources used by each of the server instances 610, 620, and 630 is lower than the lower limit of the appropriate value or is greater than the upper limit of the appropriate value. When it is determined that an amount of computing resources of any one of the server instances 610, 620, and 630 is out of the appropriate range, the procedures move on to operation S330 for component redistribution. However, when an amount of computing resources of each of the server instances 610, 620, and 630 is within the appropriate range, the procedures move on to operation S310 for continuously monitoring the server instances 610, 620, and 630.

In operation S330, to cope with a change of an amount of used computing resources in at least one server instance, the provisioning manager 530 redistributes components respectively loaded on the server instances 610, 620, and 630. When an amount of used resources is rapidly increased or decreased in a certain server instance, the component redistribution is performed so as to equalize amounts of used resources of the server instances 610, 620, and 630. The component redistribution may be performed through the above-described operations (loop of S30, S40, and S45) of FIG. 3. By virtue of the component redistribution, resource utilization of the server instance causing a problem may be stabilized.

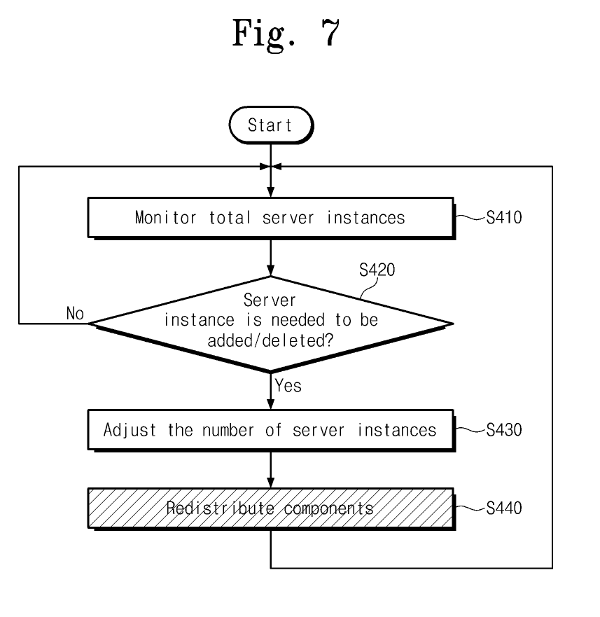

FIG. 7 is a flow chart illustrating the method for redistributing components when a total amount of resources used by all components is increased. Referring to FIG. 7, the component redistribution method of the present invention may be applied not only when an amount of required resources of a particular component deviates from an appropriate range but also when a total amount of required resources of all components deviates from an appropriate range. This phenomenon occurs when a sum of respective changes of resources used by all components is relatively high even though each resource usage variation of each component is not much high. The sum of respective changes of resource usage may affect overall performance of the distributed computing system.

In operation S410, the provisioning manager 530 monitors all of the server instances 610, 620, and 630. The provisioning manager 530 monitors a total amount of computing resources used in the server instances 610, 620, and 630.

In operation S420, the provisioning manager 530 determines whether a total amount of computing resources used by the server instances 610, 620, and 630 is within an appropriate range. When the total amount of computing resources used by the server instances 610, 620, and 630 is within the appropriate range, the procedures return to operation S410 for continuously monitoring the server instances 610, 620, and 610. On the contrary, when the total amount of computing resources used by the server instances 610, 620, and 630 is out of the appropriate range, and thus the number of server instances is needed to be adjusted, the procedures return to operation S430.

In operation S430, the provisioning manager 530 adjusts the number of server instances. For example, when the total amount of computing resources used by the server instances 610, 620, and 630 exceeds an upper limit of an appropriate value, a new server instance is added. On the contrary, when the total amount of computing resources used by the server instances 610, 620, and 630 is lower than a lower limit of the appropriate value, a certain single server instance may be removed.

In operation S440, a new component configuration over the server instances is performed based on the adjusted number of server instances. The provisioning manager 530 redistributes components respectively loaded on the adjusted server instances. The component redistribution may be performed through the above-described operations (loop of S30, S40, and S45) of FIG. 3. By virtue of the component redistribution, the resource utilization of every server instance may be stabilized. When the component redistribution is completed, the procedures move on to operation S410 for monitoring the utilization of the total server instances of which the number has been changed.

According to an embodiment of the present invention, component-based applications or components can be dynamically allocated to a plurality of server instances according to interdependent relations among components and a usage amount of the components so as to be provisioned. By virtue of this function, a load of server configuration and management can be remarkably reduced when types of the components and applications are various.

Further, according to an embodiment of the present invention, unnecessary component installation and invocations between server instances can be minimized in comparison with a dynamic provisioning method which does not consider the interdependent relations among components, thereby improving efficiency of provisioning and execution of components.

Moreover, according to an embodiment of the present invention, the component redistribution can be rapidly performed by minimizing redistribution of interrelated components over the server instances, and thus overall performance of the system can be improved.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method for distributing interdependent components of a distributed computing system, the method comprising:
determining an appropriate number of available server instances;
classifying a plurality of components loaded on the distributed computing system into clusters of which the number is equal to the number of the available server instances with reference to interdependent relations among the components;
calculating a computing resource request amount for each of the component clusters classified;
adjusting each of the computing resource request amounts of the component clusters to a value within an appropriate range by redistributing the components; and
allocating the clusters, of which the computing resource request amounts are adjusted, to the available server instances.

2. The method of claim 1, wherein the plurality of components include an application or module.

3. The method of claim 1, wherein the classifying of the plurality of components comprises:
measuring the interdependent relations by configuring coordinates respectively corresponding to the plurality of components and by allocating ‘0’ or ‘1’ according to whether there is an interdependent relation between one component and another component; and
dividing the plurality of components into the clusters of which the number corresponds to the number of the available server instances by using logic distances among the plurality of components.

4. The method of claim 3, wherein the plurality of components are divided according to a K-means algorithm which aggregates points of which the logic distances are close to each other.

5. The method of claim 1, wherein during the adjusting of each of the computing resource request amounts of the component clusters, a component cluster of which the computing resource request amount is lower than a lower limit of the appropriate range is allowed to include a component of an adjacent cluster.

6. The method of claim 5, wherein for a component cluster of which the computing resource request amount exceeds an upper limit of the appropriate range, the farthest component from a center of the exceeding cluster is included in adjacent another cluster.

7. The method of claim 1, wherein the allocating to the available server instances comprises:
comparing respective components of the component clusters with respective components loaded on the available server instances; and
allocating a component cluster to one of the available server instances which includes many components that are same as those of the cluster.

8. The method of claim 7, wherein according to a result of the allocating to the available server instances, a server instance to which a component cluster is not allocated is removed, and in the case where a plurality of clusters are allocated to a single server instance, the single server is copied as much as the number of the plurality of clusters to allocate the plurality of clusters.

9. The method of claim 8, further comprising storing allocation information on components corresponding to the component clusters and the available server instances.

10. A method for managing components of a distributed computing system, the method comprising:
determining whether it is needed to redistribute components;
allocating one component to a server instance which loads the more components having interdependent relations with the one component when component redistribution is needed; and
adjusting components for the server instance with reference to a computing resource request amount or usage amount.

11. The method of claim 10, wherein when at least one new component is requested to be installed, the component redistribution is needed, and the one component corresponds to the new component.

12. The method of claim 10, wherein when at least one component is requested to be deleted, the component redistribution is needed.

13. The method of claim 10, wherein when the computing resource usage amount of at least one component is out of an appropriate range, the component redistribution is needed.

14. The method of claim 10, wherein when the computing resource usage amount of total server instances provided to the distributed computing system is out of an appropriate range, the component redistribution is needed.
